(19) United States
(12) Patent Application Publication
(10) Pub. No.: US 2013/0054988 A1
(43) Pub. Date: Feb. 28, 2013

(54) INTEGRATED CIRCUIT DEVICE, SIGNAL PROCESSING SYSTEM AND METHOD FOR MANAGING POWER RESOURCES OF A SIGNAL PROCESSING SYSTEM

(71) Applicants: Vladimir Litovtchenko, Ebersberg (DE); Frank Donner, Eching (DE); Michael Pallas, Munich (DE)

(72) Inventors: Vladimir Litovtchenko, Ebersberg (DE); Frank Donner, Eching (DE); Michael Pallas, Munich (DE)

(73) Assignee: FREESCALE SEMICONDUCTOR INC, Austin, TX (US)

(21) Appl. No.: 13/643,358

(22) PCT Filed: May 18, 2010
(86) PCT No.: PCT/IB2010/052207

§ 371 Date: Oct. 25, 2012

(51) Int. Cl. G06F 1/26

(52) U.S. Cl. 713/300

(57) ABSTRACT

An integrated circuit device comprises a power resource management module for managing at least one power resource of a signal processing system. The power resource management module comprises an input for receiving an indication of an intended state change for the signal processing system. The power resource management module is arranged to calculate at least one power resource load prediction for implementing the indicated system state change in response to receiving the indication of an intended state change. The power resource management module comprises an output connectable to the at least one power resource of the signal processing system for configuring the at least one power resource to fulfill the at least one power resource load prediction.

### FIELD OF THE INVENTION

The field of this invention relates to an integrated circuit device, a signal processing system and a method for managing power resources of a signal processing system.

### BACKGROUND OF THE INVENTION

In the field of signal processing systems, and in particular signal processing systems for battery powered electronic devices such as mobile communication devices, etc., it is known for such signal processing systems to comprise multiple power source and/or power sink resources. With the increasing demand for higher performance and lower power consumption, the management and control of such power resources has become an increasingly important aspect in the design of such signal processing systems.

The management and control of power resources for modern electronic devices is important, not only to optimize power usage, and thereby minimize power consumption, but also to protect components within the signal processing system from damage caused by overloading of power resources, for example due to possible application faults. The sensitivity of components within signal processing systems to such overloading of power resources has increased as tolerances have been tightened to improve performance. Accordingly, accurate management and control or power resources has become increasingly important.

### SUMMARY OF THE INVENTION

The present invention provides an integrated circuit device, a signal processing system and a method for managing power resources of a signal processing system, as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 illustrates an example of an integrated circuit device.

FIG. 2 illustrates an example of a power resource management module.

FIG. 3 illustrates an example of state transition checking.

FIGS. 4 and 5 illustrate a flowchart example of a method for managing power resources.

### DETAILED DESCRIPTION

The present invention will now be described with reference to a power resource management module for managing power resources of a signal processing system and an integrated circuit therefor. In particular, examples of the present invention will be described with reference to a power resource management module for managing power resources of a signal processing system comprising one or more signal processing blocks arranged to execute application program code. In some examples the one or more signal processing blocks may comprise any suitable form of signal processing resource such as, by way of example only, one or more central processing units (CPUs), digital signal processors (DSPs), microcontrollers, application specific integrated circuits (ASICs), embedded systems, or other suitable signal processing blocks. Furthermore, the inventive concept is not limited to the management of power resources of signal processing systems comprising application code programmable signal processing blocks, and may equally be applied to the management of power resources of other types of signal processing systems, for example a signal processing system comprising non-programmable hardware, such as, by way of example only, field programmable gate arrays (FPGAs). Accordingly, the term “signal processing block” used herein is intended to encompass such programmable and non-programmable signal processing resources, and the term “signal processing system” used herein is intended to encompass any system comprising any such signal processing block.

Furthermore, because the illustrated examples may, for the most part, be implemented using electronic components and circuits known to those skilled in the art, details will not be explained in any greater extent than that considered necessary as illustrated below, for the understanding and appreciation of the underlying concept of the present invention and in order not to obfuscate or distract from the teachings of the present invention.

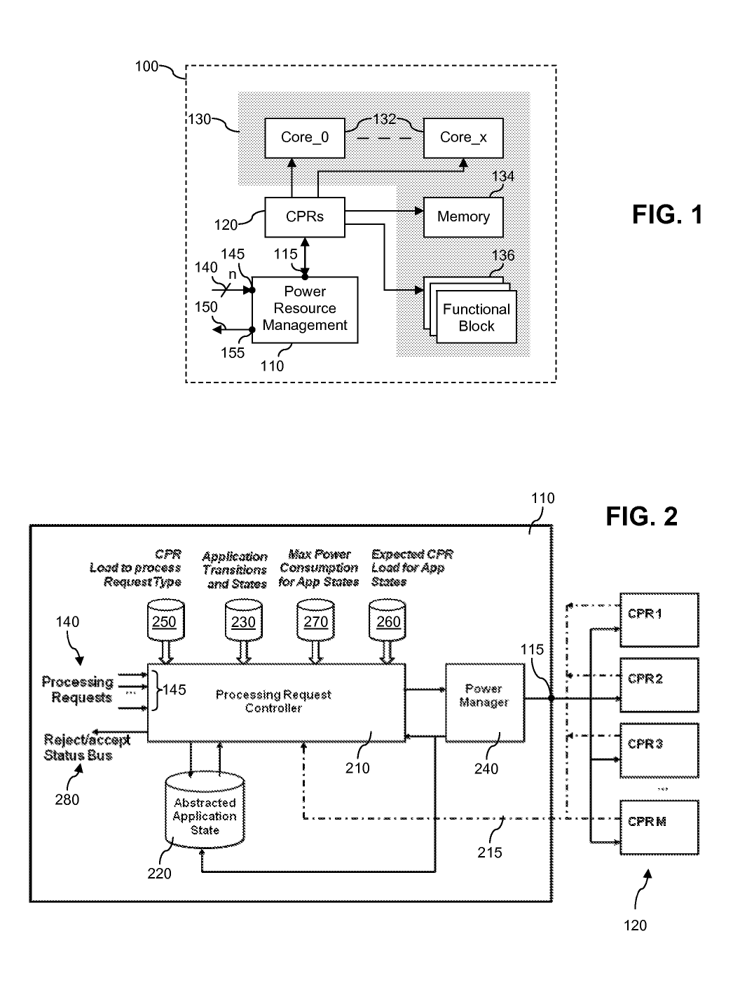

Referring now to FIG. 1, there is illustrated an example of an integrated circuit device 100 adapted in accordance with some embodiments of the present invention. The integrated circuit device 100 comprises a power resource management module 110 for managing at least one power resource of a signal processing system, which for the illustrated example comprises configurable power resources (CPRs) illustrated generally with CPR 120. It should be noted that although only a signal CPR 120 is shown, the device 100 may comprise multiple CPRs. As will be apparent from the below, the power resource manager may facilitate testing of the signal processing system, and of one or more applications running thereon. The signal processing system, illustrated generally at 130, comprises various functional blocks, which for the illustrated example comprise one or more signal processing blocks in a form of Core_0 to Core_x 132 arranged to execute application program code. The integrated circuit device 100 may comprise more blocks than just signal processing blocks, such as for example one or more memory elements 134 and one or more additional functional logic blocks 136. Such additional functional logic blocks 136 may comprise, by way of example only, a video accelerator, graphical accelerator, serial/parallel interface, etc. The configurable power resources 120 are also operably coupled to one or more of the functional blocks 132, 134, 136 of the signal processing system.

The configurable power resources 120 may comprise one or more elements that comprise a power source or power consumer that affect the power consumption of the signal processing system. Such a power resource element may comprise, by way of example only, any one or more of:
a system frequency source;
a functional block frequency source;
a sub-module/peripheral clock on/off control;
a system voltage regulator output level control;
a system voltage regulator on/off control;
a functional block voltage regulator output level control;
a function block voltage regulator on/off control;
a sub-module/peripheral power on/off control;
an output level control for external pads of the integrated circuit device;
an on/off control for external pads of the integrated circuit device;
a z-control (high impedance tri-state control) for external pads of the integrated circuit device; and/or
a slew rate control for external pads of the integrated circuit device.

The power resource management module 110 is arranged to receive at an input 145 an indication of an intended state change for the signal processing system 130, such an indication being illustrated generally at 140, and to calculate one or more power resource load predictions for implementing the indicated system state change. The power resource management module 110 is further arranged to configure by outputting via output 115 suitable control signals the configurable power resources 120 of the signal processing system 130 to fulfil the power resource load prediction(s).

In this manner, power resource loads required to implement intended system state changes may be predicted, and such power resource load predictions may be used to configure the power resources accordingly. Thus, power resources may be more accurately controlled to meet the needs of the signal processing system, whilst optimizing the power consumption thereof. Furthermore, intended system state changes that would result in unwanted peak loads may be detected and rejected. In this manner, illegal state transitions may be detected and inhibited, thereby preventing an overload of system power resources due to possible faults of applications running on the signal processing system.

In accordance with some examples, upon receipt of an indication of an intended state change for the signal processing system 130, the power resource management module 110 may be arranged to perform a state transition check to determine whether the indicated system state change is permissible. If it is determined that the indicated system state change is permissible, the power resource management module 110 may then calculate one or more power resource load predictions for implementing the indicated system state change, and configure the configurable power resource(s) 120 of the signal processing system 130 to fulfil the one or more of the power resource load predictions. Conversely, if it is determined that the indicated system state change is not permissible, the power resource management module 110 may be arranged to output at an output 155 a state change rejection signal, for example as illustrated at 150 in FIG. 1. In this manner, when an impermissible system state change is detected, such an impermissible system state change is signalled to, say, the signal processing system 130. Upon receipt of such a state change rejection signal, the signal processing system 130 may prevent the indicated system state change, or cause the system to change into a different state, for example a ‘safe’ state or system default state. In such a safe or system default state, the error condition that caused the system to attempt an impermissible system state change may be detected and removed, thereby, for example, enabling the signal processing system 130 to subsequently resume normal operation. Thus, by detecting and signalling impermissible system state changes, the power resource management module 110 enables the graceful detection and behaviour of the system and handling of such errors by the system.

In accordance with some examples, upon receipt of an indication of an intended system state change, the power resource management module 110 may be arranged to map the indicated system state change to an abstracted system state model. The power resource management module 110 may then retrieve state and transition configuration data for the abstracted system state model to which the indicated system state change has been mapped. The power resource management module 100 may then determine whether or not the indicated system state change is permissible based at least partly on the retrieved state and transition configuration data for the abstracted system state model. In this manner, a simplified, abstracted model of operating states for the signal processing system 130 may be used to determine whether the indicated system state change is permissible, with state and transition configuration data being provided for the simplified, abstracted system model rather than for the more complex actual system state model.

The power resource management module 110 may be further arranged, upon receipt of an indication 140 of an intended system state change, to retrieve a maximum power resource load value for each of the configurable power resource(s) 120 of the signal processing system 130, and to compare the one or more calculated power resource load prediction(s) for implementing the indicated system state change to the one or more maximum power resource load value(s). If all of the power resource load predictions for implementing the indicated system state change exceed the maximum power resource load value, the power resource management module 110 may be arranged to output a state change rejection signal. In this manner, if an intended system state change would result in too high a power consumption to implement, a state change rejection may be signalled to, say, the signal processing system 130. Upon receipt of such a state change rejection signal, the signal processing system 130 may prevent the indicated system state change, or cause the system to change into a different state, for example a safe state or system default state. In such a safe or system default state, the error condition that caused the system to attempt such a system state change that would result in too high a power consumption may be detected and removed, thereby enabling the signal processing system 130 to subsequently resume normal operation. Thus, by predicting the one or more power resource load(s) required to implement system state changes, and comparing it/them to one or more maximum load value(s), the power resource management module 110 enables the graceful detection and behaviour of the system and handling of such errors.

In accordance with some examples, upon receipt of an indication of an intended state change for the signal processing system 130, the power resource management module 110 may be arranged to map the indicated system state change to an abstracted system state. The power resource management module 110 may then retrieve a maximum power resource load value for the abstracted system state, and compare the power resource load prediction for implementing the indicated system state change to the maximum power resource load value for the abstracted system state. If all power resource load predictions for implementing the indicated system state change exceed the maximum power resource load value for the abstracted system state, the power resource management module 110 may then be arranged to output a state change rejection signal. In this manner, a simplified, abstracted model of operating states for the signal processing system 130 may be used to define maximum power resource loads. The power resource management module 110 may then determine if an intended system state change would result in too high a power consumption to implement for the simplified, abstracted system model rather than for the more complex actual system state model.

The power resource management module 110 may further be arranged, upon receipt of an indication of an intended state change for the signal processing system 130, to retrieve power resource load information for power resources 120 capable of implementing the indicated system state change. The power resource management module 110 may calculate one or more power resource load prediction(s) for power resources 120 capable of implementing the indicated system state change based on the retrieved power resource load information. The power resource management module 110 may then compare the one or more calculated power resource load prediction(s) to one or more maximum power resource load value(s) for the respective power resource(s). If at least one power resource load prediction for implementing the indicated system state change is below the maximum power resource load value for the respective power resource, the power resource management module 110 may to configure the power resource for which a load prediction is below the respective maximum power resource load value in order to fulfil the respective power resource load prediction. Such power resource load prediction information upon which the power resource load predictions is/are (at least partly) based, may comprise one or more of: a required load to implement the intended system state change for the power resources, an expected load for an abstracted system state to which the intended state change is mapped, a current power resource status, or any other suitable type of information.

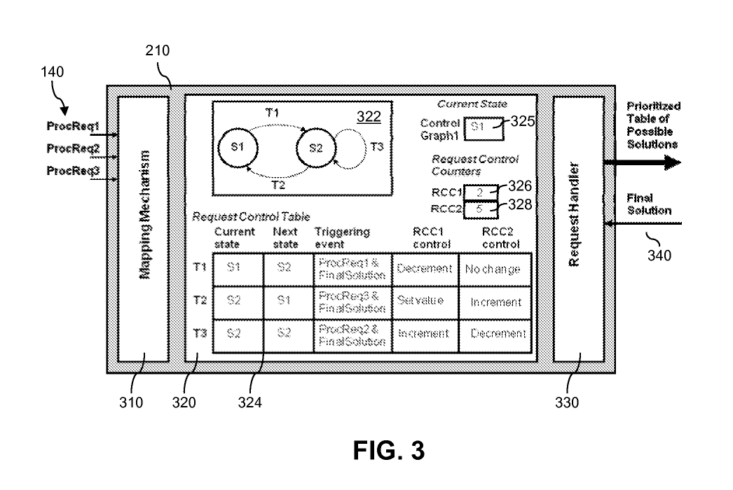

Referring now to FIG. 2, there is illustrated an example of the power resource management module 110 suitable for the example of FIG. 1. The power resource management module 110 illustrated in FIG. 2 is connected to receive, at one or more inputs 145, one or more indication(s) of one or more intended state change(s) in a form of one or more processing request(s) 140 from the signal processing system 130. The power resource management module 110 comprises a processing request controller 210. The processing requests 140 are received by the processing request controller 210. Upon receipt of one or more processing requests 140, the processing request controller 210 calculates one or more resource load predictions for implementing the processing request(s). The one or more resource load predictions is/are then provided to a power manager module 240, which is connected to the processing request controller 210 and in response to receiving the load predictions configures the configurable power resources of the signal processing system 130 via outputs 115 to fulfil the one or more resource load predictions.

In the illustrated example of the power resource management module 110, the processing request controller 210 is operably coupled to a dynamic memory space 220 in which a current abstracted system state is stored. The processing request controller 210 can map received processing requests to an abstracted system state. For the illustrated example, such a dynamic memory space comprises a dynamic database. Upon the configurable power resources 120 being configured to fulfil one or more resource load predictions, the processing request controller 210 dynamically updates the current abstracted system state stored within the dynamic database 220 to update the current system state with the received requests. The processing request controller 210 is further operably coupled to a first static memory space 230, which for the illustrated example comprises a static database, in which state and transition configuration data for the abstracted system states is stored. Accordingly, having mapped received processing request(s) to an abstracted system state, the processing request controller 210 can retrieve state and transition configuration data for the abstracted system state from the static database 230, and determine therefrom whether the received processing request is permissible.

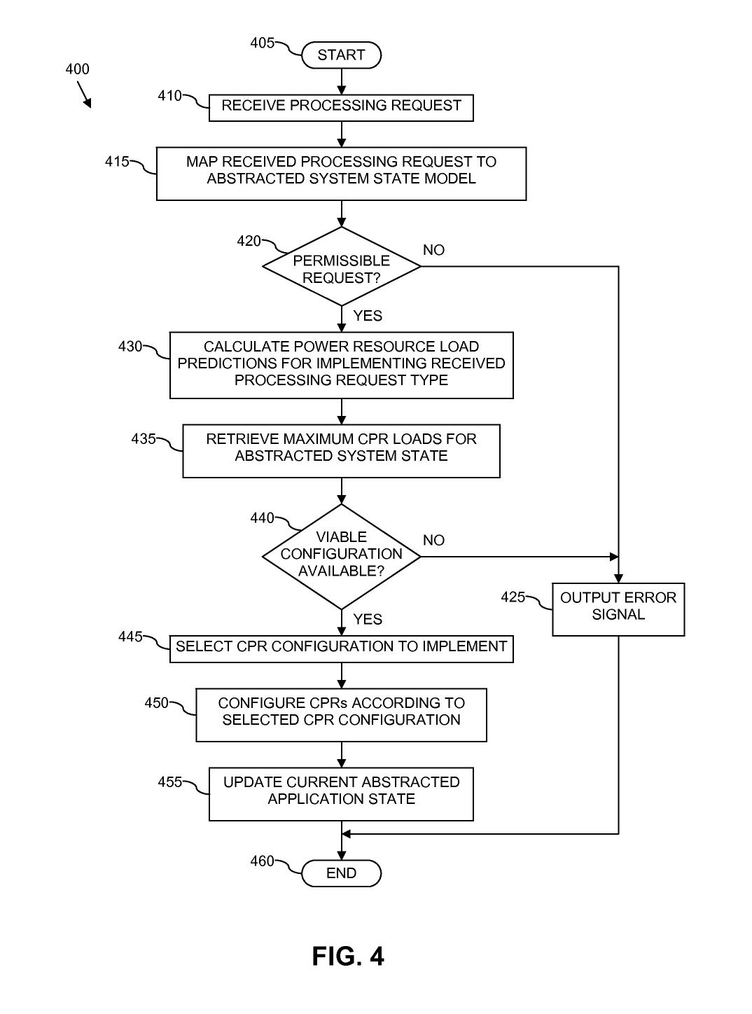

FIG. 3 illustrates an example of state transition checking as may be performed by the processing request controller 210. For the example illustrated in FIG. 3, the processing request controller 210 comprises a mapping mechanism 310 (which may be configured/implemented using one or more signal processing modules and one or more memory modules) which (when controller 210 is in operation) maps the received processing requests 140 to an abstracted system state. The processing request controller 210 further comprises a state transition checking mechanism 320, which performs state transition checking on the received processing requests with respect to the defined system states of the abstracted system state model to which they are mapped, in order to determine whether or not the received processing requests are permissible.

For the example illustrated in FIG. 3, received processing requests 140 are mapped to an abstracted system state model, illustrated generally at 322. The abstracted system state model 322 comprises two defined system states, ‘S1’ and ‘S2’, and three system state transitions, ‘T1’, ‘T2’ and ‘T3’. It will be apparent that the shown model is simplified for ease of understanding and that the model may comprise more states and transitions. As previously mentioned, the processing request controller 210 is arranged to retrieve state and transition configuration data for the abstracted system state from the static database 230 of FIG. 2 and to determine whether the received processing request is permissible. For the example illustrated in FIG. 3, the state and transition configuration data is illustrated in state transition table 324. The state transition table 324 comprises details for each of the abstracted state transitions T1, T2 and T3, such details including, for example, the current abstracted system state and the next abstracted system state for each abstracted state transition, a triggering event for each abstracted state transition and, for the illustrated example, counter control parameters for request control counters 326, 328. For the illustrated example, the triggering events for each abstracted state transition comprises the receipt of a corresponding processing request 140 and a final solution (described below) 340 for the received processing request. A current abstracted system state value is maintained at 325.

Upon receipt of a first processing request 140, the processing request controller 210 maps the received first processing request 140 to the abstracted system state model. For example, for the example illustrated in FIG. 3, upon receipt of a ProcReq1 processing request, the received processing request is mapped to abstracted state transition T1, based on ProcReq1 forming a part of the triggering event for that abstracted state transition. The state transition checking mechanism 320 may subsequently check that the abstracted state to which the received processing request has been mapped is valid for the current state. As can be seen from the state transition table 324, abstracted state transition T1 is valid for a current abstracted state of S1, which is consistent with the current abstracted system state value, as illustrated at 325. Accordingly, for this example, the abstracted state transition T1 to which the received processing request has been mapped is valid. Conversely, if a received processing request is mapped to an invalid abstracted state transition, for example T2 or T3 when the current abstracted system state is S1, a state transition error signal may be output to indicate that an invalid system state transition has been detected, for example via reject/accept status bus 280 illustrated in FIG. 2.

For the illustrated example, the state transition checking mechanism 320 may perform further validation of indicated state transitions. For example, the state transition table 324 further comprises counter control parameters for request control counters 326, 328. Such counter control parameters define operations to be performed on the respective request control counters upon the corresponding event triggers occurring. Thus, for the abstracted state transition T1, upon receipt of the processing request ProcReq1 and receipt of a final solution (described below) 340 for that processing request, the first request control counter 326 is decremented, whilst the second request control counter 328 is left unchanged. If either of the request control counter values equal predefined values (for example values of zero) following the operations defined in the state transition table 324 for a mapped transition, a state transition error signal may also be output to indicate that an invalid system state transition has been detected. In this manner, overly repetitive processing requests that indicate an error within the signal processing system may be detected and signalled, for example via reject/accept status bus 280 illustrated in FIG. 2.

In this example, the processing request controller 210 illustrated in FIG. 3 further comprises a request handler 330. The request handler 330 is arranged to receive processing request 140 and the abstracted state transition to which the processing request has been mapped, and to calculate one or more power resource load prediction(s) for implementing the received processing request based on the received data. The request handler 330 then provides the one or more power resource load prediction(s) to the power manager module 240 of FIG. 2. In particular for the illustrated example, the request handler 330 is connected to the power manager module 240 to provide the one or more power resource load prediction(s) to the power manager module 240 within a prioritised table of possible solutions, as described in greater detail below.

In accordance with some examples, the processing request controller 210, and in particular the request handler 330 of FIG. 3, may be arranged to calculate power resource load predictions based on at least one from a group consisting of:
a type of indicated system state change;
a power resource load value for implementing the indicated system state change;
an expected power resource load for a respective abstracted system state; and
a maximum power resource loads for a respective abstracted system state.

However, the load prediction may additionally or alternatively be based on any other suitable type of information. Referring back to FIG. 2, the processing request controller 210 is, for example, further operably coupled to a second static memory space 250 in which power resource load data for implementing processing request types is stored. In this manner, the processing request controller 210 is able to retrieve power resource load data for implementing a received processing request. The processing request controller 210 is further operably coupled to a further static memory space 260 in which one or more expected power resource load value(s) for abstracted system states is/are stored. In this manner, the processing request controller 210 is able to retrieve expected power resource load values for an abstracted system state to which a received processing request is mapped. The processing request controller 210 is still further operably coupled to a still further static memory space 270 in which one or more maximum power resource load value(s) for abstracted system states are stored. In this manner, the processing request controller 210 is able to retrieve maximum power resource load values for an abstracted system state to which a received processing request is mapped. For the illustrated example, the static memory spaces 250, 260, 270 are also in the form of static databases. The processing request controller 210 is also arranged to receive a power resource utilisation indication, illustrated generally at 215, the power resource utilisation indication 215 providing a current (immediate) load of the power resources to the processing request controller 210. This data is returned by the CPR modules 120 as status data.

In this manner, the processing request controller 210 is provided with an indication of what power resource utilisation might be expected for a current abstracted system state.

Upon receipt of a processing request, the processing request controller 210 may retrieve power resource information for power resource configurations capable of implementing the received processing request from the static databases 250, 260, 270. Thus, for the illustrated example, the processing request controller 210 may receive power resource information comprising at least one from a group consisting of:
power resource load data for implementing the received processing request type;
one or more expected power resource load value(s) for an abstracted system state to which the received processing request is mapped; and
one or more maximum power resource load value(s) for an abstracted system state to which the received processing request is mapped.

Having retrieved the power resource load information, the processing request controller 210 may then calculate power resource load predictions for power resources capable of implementing the received processing request, based at least partly on the retrieved power resource load information. For example, for each power resource configuration capable of implementing the received processing request type, a power resource load prediction may be calculated for each power resource involved as follows:

PRL_{PREDICTION}=PRL_{PROC}_{_{—}}_{REQ}+PRL_{ABST}_{_{—}}_{STATE}+PRL_{CURRENT} [Eq. 1]

Where:

PRL_{PREDICTION} represents a power resource load prediction, PRL_{PROC}_{_{—}}_{REQ} represents a power resource load value for implementing the received processing request type,

PRL_{CURRENT} represents a current power resource load status. A PRL_{CURRENT} value is used because previous request(s) may still be under processing at the moment when a new request of the same type is asserted to the system, and

PRL_{ABST}_{_{—}}_{STATE} represents an expected power resource load value for an abstracted state to which the received processing request is mapped. The PRL_{ABST}_{_{—}}_{STATE} value may not necessarily consider several instances of requests under processing; however it is only a prediction in a case of an “ideal load” (for instance, only one request per request type/group is processed in an “ideal” case) in the specified system state. Thus, in this manner, the PRL_{CURRENT} may provide a value of load caused by those additional requests that still stay under processing. However, as illustrated in equation [1], the PRL_{CURRENT} value is still required to add a new load value, which will be caused by acceptance of a new request with the value PRL_proc_req.

Thus, in a case where two power resources, CPR1 and CPR2, are capable of independently implementing ProcReq1 type processing requests, the retrieved power resource load data for implementing the received processing request type may comprise for example:
CPR1 load for ProcReq1=10%
CPR2 load for ProcReq1=20%

With regard to the expected power resource load values for an abstracted system state to which the received processing request is mapped, and referring back to FIG. 3, as previously mentioned a ProcReq1 processing request may be mapped to an abstracted state transition T1. As illustrated in the state transition table 324, for the illustrated example, this may comprise a current abstracted system state of S1 and a next abstracted system state of S2. Accordingly, for the illustrated example, the ProcReq1 processing request type may be mapped to an abstracted state of S2, since this will be the resulting abstracted state for the system following implementation of the processing request. Thus, having retrieved the power resource load values for implementing the requested processing request, the processing request controller 210 may then retrieve the one or more expected power resource load value(s) for at least the power resources capable of implementing the received processing request type, and corresponding to the abstracted system state to which the received processing request is mapped. Thus, for the above example, the retrieved one or more expected power resource load value(s) for the abstracted state to which the received processing request is mapped may comprise, for example:
S2: CPR1=20%; CPR2=35%

Having retrieved the one or more expected power resource load value(s) for the abstracted state to which the received processing request is mapped, the processing request controller 210 may then retrieve one or more maximum power resource load value(s) for at least the power resources capable of implementing the received processing request type, and corresponding to the abstracted system state to which the received processing request is mapped. Thus, for the above example, the retrieved maximum power resource load values may comprise, for example:
S2: CPR1=40%; CPR2 40%

For the above example, the processing request controller 210 may further determine the current power resource status for the power resource that is capable of implementing the received processing request type, which for the example illustrated in FIG. 2 is achieved by way of the power resource utilisation indication 215. For the above example, the current power resource status for the power resources that is/are capable of implementing the received processing request type may comprise, for example:
CPR1=4%; CPR2=15%

Having retrieved the power resource load information, the processing request controller 210 may then calculate one or more power resource load prediction(s) for the power resource configurations capable of implementing the received processing request. Thus, in the above case where two power resources, CPR1 and CPR2, are capable of independently implementing ProcReq1 type processing requests, upon receipt of such a request, the processing request controller 210 may calculate two power resource load predictions, which for the above retrieved power resource load information may comprise:

CPR1: PRL_{PREDICTION}=10%+20%+4%=34% [Eq. 2]

CPR2: PRL_{PREDICTION}=20%+35%+15%=70% [Eq. 3]

The one or more power resource calculation(s) are then compared to the retrieved one or more maximum power resource load value(s) for the respective power resources and corresponding to the abstracted system state to which the received processing request is mapped. In this manner, undesirably high peak loads for power resources may be identified.

For example, the power resource load prediction calculated above for the first power resource CPR1, in order to implement the received processing request is a value of ‘34%’ of the power resource's capabilities. From the retrieved power resource load information, the maximum resource load for this first power resource CPR1 in the abstracted system state to which the received processing request was mapped is ‘40%’. Thus, it may be determined that this value is within the specified system limits, as defined in the data stored within the static memory areas 250, 260, 270, for the received processing request to be implemented using this first power resource.

However, the power resource load prediction calculated above for the second power resource CPR2 to implement the received processing request is a value of ‘70%’ of the power resource's capabilities. From the retrieved power resource load information, the maximum resource load for this second power resource CPR2 in the abstracted system state to which the received processing request was mapped is also only ‘40%’. Accordingly, implementing the received processing request using the second power resource would result in the power resource load exceeding the specified system limits as defined in the data stored within the static memory areas 250, 260, 270.

The processing request controller 210 may be arranged to output, when all of the calculated power resource load predictions for implementing a received processing request exceed the maximum power resource load values for the respective power resources, a state change rejection signal, for example via reject/accept status bus 280. In this manner, if a received processing request is unable to be implemented without exceeding specified system limits, it may be assumed that an error state has occurred within the signal processing system, and that the detection of such an error is signalled by way of the state change rejection signal 280.

However, the processing request controller 210 may be arranged to pass on, when at least one power resource load prediction for implementing the received processing request is below the maximum power resource load value(s) for the respective power resource(s), those power resource load predictions that are below the maximum power resource load value(s) to the power manager 240. In accordance with some examples, the processing request controller 210 may arrange those power resource load predictions that are below the maximum power resource load value(s) to be loaded into a prioritised table of possible solutions, for example based on prioritisations provided within the power resource load data for implementing processing request types stored within the static database 250.

Upon receipt of the power resource load predictions, the power manager 240 may then select one of the received power resource load predictions to provide a final solution, and may configure one or more of the power resources 120 to fulfil the selected power resource load prediction. For example, the power manager 240 may select a power resource load prediction based on its position within the prioritised table of possible solutions.

Having selected a final solution for configuring one or more of the power resources 120 to implement the received processing request, the power manager 240 may be arranged to provide the final solution back to the processing request controller 210, in order to confirm that the processing request has been implemented. Upon receipt of the final solution, or some other indication that the processing request has been implemented, the processing request controller may then update the current abstracted system state 325, and for the example illustrated in FIG. 3 the request control counters 326, 328, in accordance with the state and transition configuration data located within the state transition table 324.

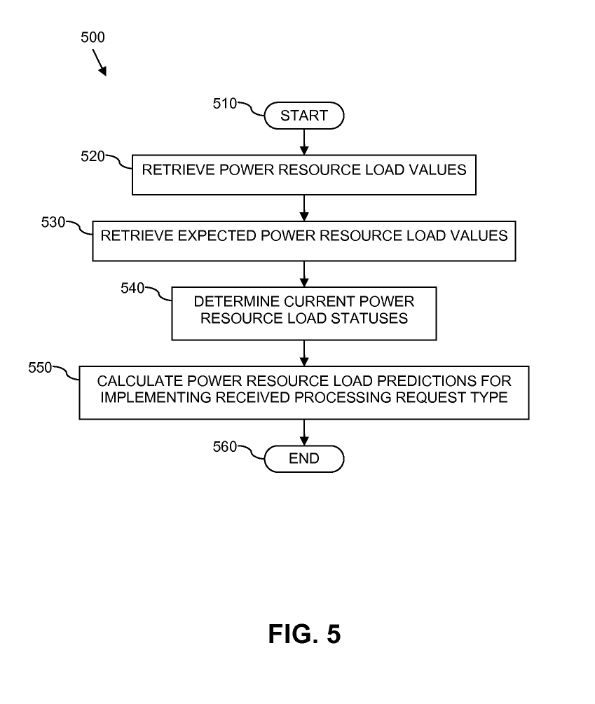

Referring now to FIG. 4, there is illustrated a simplified flowchart 400 of an example of a method for managing power resources of a signal processing system, according to some embodiments of the present invention. The method comprises receiving an indication of an intended state change for the signal processing system, calculating at least one power resource load prediction for implementing the indicated system state change, and configuring at least one power resource of the signal processing system to fulfil the at least one power resource load prediction.

The method starts at step 405, and moves on to step 410 with the receipt of an indication of an intended state change in a form of a processing request. For the illustrated example, the received processing request is then mapped to an abstracted system state model at step 415. It is then determined as to whether or not the received processing request is permissible, at step 420, for example with respect to the abstracted system state model to which it is mapped. If it is determined that the received processing request is not permissible, the method moves on to step 425 and an error signal is output. The method then ends at step 460. Conversely, if it is determined that the received processing request is permissible at step 420, the method moves on to step 430 where power resource load predictions are calculated for power resource configurations that are capable of implementing the received processing request type, for example as described in greater detail below with reference to FIG. 5. Next, at step 435, one or more maximum power resource load(s) for an abstracted system state to which the received processing request has been mapped is/are retrieved. It is then determined whether or not a viable power resource configuration for implementing the received processing request is available based on a comparison of one or more calculated power resource load prediction(s) to the retrieved one or more maximum power resource load(s) for the abstracted system state to which the received processing request has been mapped. If no viable power resource configuration is available for implementing the received processing request, the method moves on to step 425, where an error signal is output, and the method ends at step 460. Conversely, if one or more viable power resource configurations are available for implementing the received processing request, the method moves on to step 445 where a viable power resource configuration is selected to be implemented. Next, at step 450, one or more power resource(s) is/are configured to fulfil the selected power resource configuration, and a current abstracted system state is updated at step 455. The method then ends at step 460.

Referring now to FIG. 5, there is illustrated a simplified flowchart 500 of an example of a method for calculating one or more power resource load prediction(s), such as may be used to implement step 420 of FIG. 4. The method starts at step 510, and moves on to step 520 where one or more power resource load value(s) for implementing the received processing request type is/are retrieved. Next, at step 530, one or more expected power resource load value(s) for an abstracted system state to which the received processing request has been mapped is/are retrieved. Current power resource status(es) is/are then determined at step 540. One or more power resource load prediction(s) is/are then calculated based on the retrieved one or more power resource load value(s) for implementing the received processing request type and the expected one or more power resource load value(s) for an abstracted system state to which the received processing request, and on the determined one or more current power resource status(es), at step 550. The method then ends at step 560.

In accordance with some examples, there has been described a method and apparatus in which system power requirements for the next system state may be estimated, and power resources allocated based on this estimation. In this manner, efficient use of energy and power consumption may be achieved, for example for portable and battery operated devices. Furthermore, flexible configuration options, for example by way of data stored within the static memory spaces, such as the static databases 230, 250, 260, 270 illustrated in FIG. 2, enable easy adaptation of the power management apparatus to a wide range of possible applications and architectures.

Faults resulting in more frequent processing requests than planned, or requests that don't fit to the current application state or required too high power consumption, may be detected, and an error indicator output to the signal processing system. In this manner, such faults are detected and suppressed without undue any additional burden to the signal processing system. Furthermore, upon following detection and suppression of such a fault, subsequent correct requests may be accepted, thereby supporting and enabling fault tolerant behavior. Significantly, if a detected fault is a transient one, the system is able to resume its normal operation mode.

The signal processing system may be prevented from operating outside of specified system limits, for example as defined in the data stored within the static memory areas 250, 260, 270 of FIG. 2. Furthermore, by performing state transition checks, such as described above with reference to FIG. 2, the signal processing system may be made more robust, and prohibit invalid operation thereof. If the signal processing system comprises, say, a microcontroller, then the microcontroller can be made instantaneously aware of a potential threatening condition. This will then allow the microcontroller (or an application running thereon) to start to either change one or more states or to start to move into some type of safe or system default state. By moving into this safe or system default state, the error condition may subsequently be identified and corrected, thereby enabling the signal processing system to recover into a normal operating mode.

The use of a power resource manager adapted in accordance with aspects of the present invention, and implemented by way of a hardware module such as a state machine, may alleviate some of the application coding concerns away from an application developer. The application developer may thereby focus more on system level and architecture coding concerns. In this manner, the application developer is at a more abstract level as far as the power management is concerned, thereby simplifying the system design. By moving this level of power resource control from an application developer to the hardware solution may reduce the amount of development of the application developer. At the more abstract level, the application developer may be provided with a more pre-determined data set to manipulate, and reducing this overhead will improve system robustness.

The invention may also be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; non-volatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

For example, the power resource manager may be implemented by way of a hardware module such as a state machine. Thereby, an application running on a signal processing block of the signal processing system can be enabled to be free from the direct control of power resource allocations and/or setup for the signal processing system during run-time, thereby freeing up processing resources of the signal processing system, which may be used for, say, time-critical tasks and the like.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, for the example illustrated in FIG. 2, the power manager module 240 is illustrated as comprising a separate function block as the processing request controller 210. However, it is contemplated that the functionality of the power manager module 240 may alternatively form an integrated part of the processing request controller 210.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected”, or “operably coupled”, to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. For example, and as illustrated in FIG. 1, the signal processing system 130 may be provided within a single integrated circuit device 100, and the power resource management module 110 may comprise an integral part of the single integrated circuit device 100. Alternatively, the signal processing system 130 may be provided over a plurality of integrated circuit devices. Accordingly, the power resource management module 110 may form an integral part of one of those integrated circuit devices, or may be distributed over two or more of those integrated circuit devices in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an”, as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. An integrated circuit device comprising a power resource management module for managing at least one power resource of a signal processing system, the power resource management module comprising:
an input for receiving an indication of an intended state change for the signal processing system;
the power resource management module is arranged to calculate at least one power resource load prediction for implementing the indicated system state change in response to receiving the indication of an intended state change; and
the power resource management module comprises an output connectable to the at least one power resource of the signal processing system for configuring the at least one power resource to fulfill the at least one power resource load prediction.

2. The integrated circuit device of claim 1 wherein the power resource management module is further arranged to, upon receipt of an indication of an intended state change for the signal processing system, perform a state transition check to determine whether the indicated system state change is permissible; and to output a state change rejection signal when it is determined that the indicated system state change is not permissible.

3. The integrated circuit device of claim 1 wherein, upon receipt of an indication of an intended state change for the signal processing system, the power resource management module is further arranged to map the indicated system state change to an abstracted system state model.

4. The integrated circuit device of claim 1 wherein the power resource management module is further arranged, upon receipt of an indication of an intended state change for the signal processing system, to retrieve state and/or transition configuration data for the abstracted system state model; and to determine whether the indicated system state change is permissible based at least partly on the retrieved state and transition configuration data for the abstracted system state model.

5. The integrated circuit device of claim 1 wherein the power resource management module is further arranged to, upon receipt of an indication of an intended state change for the signal processing system,
retrieve a maximum power resource load value for the at least one power resource;
compare the calculated at least one power resource load prediction for implementing the indicated system state change to the retrieved maximum power resource load value; and
output a state change rejection signal, if all power resource load predictions for implementing the indicated system state change exceed the maximum power resource load value.

6. The integrated circuit device of claim 3 wherein the power resource management module is further arranged to, upon receipt of an indication of an intended state change for the signal processing system,
retrieve a maximum power resource load value for the abstracted system state model;
compare the at least one power resource load prediction to the maximum power resource load value for the abstracted system state model; and
if all power resource load predictions for implementing the indicated system state change exceed the maximum power resource load value for the abstracted system state, output a state change rejection signal.

7. The integrated circuit device of claim 1 wherein the power resource management module is further arranged to, upon receipt of an indication of an intended state change for the signal processing system,
retrieve power resource load information for one or more power resource(s) capable of implementing the indicated system state change; and
calculate one or more power resource load prediction(s) for the one or more power resource(s) capable of implementing the indicated system state change based at least partly on the retrieved power resource load information.

8. The integrated circuit device of claim 7 wherein the power resource management module is further arranged to, upon receipt of an indication of an intended state change for the signal processing system,
compare the calculated one or more power resource load prediction(s) to one or more maximum power resource load value(s) for the respective power resources; and
configure at least one power resource of the signal processing system for which a load prediction is below the maximum power resource load value to fulfill one of the power resource load predictions, if at least one power resource load prediction for implementing the indicated system state change is below the maximum power resource load value for the respective power resource.

9. The integrated circuit device of claim 1 wherein the power resource management module is further arranged, upon receipt of an indication of an intended state change for the signal processing system, to calculate a power resource load prediction for implementing the indicated system state change based at least partly on at least one from a group consisting of:
a required load to implement the intended system state change for the at least one power resource;
an expected load for an abstracted system state to which the intended state change is mapped; and
a current power resource status.

10. A signal processing system comprising a power resource management module for managing at least one power resource of the signal processing system, wherein:
the power resource management module comprises an input for receiving an indication of an intended state change for the signal processing system;
the power resource management module is arranged to calculate at least one power resource load prediction for implementing the indicated system state change in response to receiving the indication of an intended state change; and
the power resource management module comprises an output connectable to the at least one power resource of the signal processing system for configuring the at least one power resource (120) to fulfill the at least one power resource load prediction.

11. A method for managing power resources of a signal processing system, the method comprising:
receiving an indication of an intended state change for the signal processing system;
calculating at least one power resource load prediction for implementing the indicate system state change in response to receiving the indication of an intended state change; and
configuring at least one power resource of the signal processing system to fulfill the at least one power resource load prediction.

12. (canceled)

13. The method of claim 11 further comprising upon receipt of an indication of an intended state change for the signal processing system, performing a state transition check to determine whether the indicated system state change is permissible; and outputting a state change rejection signal when it is determined that the indicated system state change is not permissible.

14. The method of claim 11 further comprising, upon receipt of an indication of an intended state change for the signal processing system, mapping the indicated system state change to an abstracted system state model.

15. The method of claim 11 further comprising, upon receipt of an indication of an intended state change for the signal processing system, retrieving state and/or transition configuration data for the abstracted system state model; and determining whether the indicated system state change is permissible based at least partly on the retrieved state and transition configuration data for the abstracted system state model.

16. The method of claim 11 further comprising, upon receipt of an indication of an intended state change for the signal processing system,
retrieving a maximum power resource load value for the at least one power resource;
comparing the calculated at least one power resource load prediction for implementing the indicated system state change to the retrieved maximum power resource load value; and
outputting a state change rejection signal, if all power resource load predictions for implementing the indicated system state change exceed the maximum power resource load value.

17. The method of claim 14 further comprising, upon receipt of an indication of an intended state change for the signal processing system,
retrieving a maximum power resource load value for the abstracted system state model;
comparing the at least one power resource load prediction to the maximum power resource load value for the abstracted system state model; and
if all power resource load predictions for implementing the indicated system state change exceed the maximum power resource load value for the abstracted system state, outputting a state change rejection signal.

18. The method of claim 11 further comprising, upon receipt of an indication of an intended state change for the signal processing system,
retrieving power resource load information for one or more power resource(s) capable of implementing the indicated system state change; and
calculating one or more power resource load prediction(s) for the one or more power resource(s) capable of implementing the indicated system state change based at least partly on the retrieved power resource load information.

19. The method of claim 18 further comprising, upon receipt of an indication of an intended state change for the signal processing system,
comparing the calculated one or more power resource load prediction(s) to one or more maximum power resource load value(s) for the respective power resources; and
configuring at least one power resource of the signal processing system for which a load prediction is below the maximum power resource load value to fulfill one of the power resource load predictions, if at least one power resource load prediction for implementing the indicated system state change is below the maximum power resource load value for the respective power resource.

20. The method of claim 11 further comprising, upon receipt of an indication of an intended state change for the signal processing system, calculating a power resource load prediction for implementing the indicated system state change based at least partly on at least one from a group consisting of:
a required load to implement the intended system state change for the at least one power resource;
an expected load for an abstracted system state to which the intended state change is mapped; and
a current power resource status.
